(19) United States
(12) Patent Application Publication
(10) Pub. No.: US 2026/0204068 A1
(43) Pub. Date: Jul. 16, 2026

(54) VIDEO FREEZE DETECTION CIRCUIT

(71) Applicant: ROHM CO., LTD., Kyoto (JP)

(72) Inventor: Takuya MOTOHASHI, Kyoto (JP)

(73) Assignee: ROHM CO., LTD., Kyoto (JP)

(21) Appl. No.: 19/447,346

(22) Filed: Jan. 13, 2026

(30) Foreign Application Priority Data
Jan. 16, 2025 (JP) 2025-006349

(51) Int. Cl. G06V 20/40; G06T 1/60

(52) U.S. Cl. CPC G06V 20/48; G06T 1/60

(57) ABSTRACT

A video freeze detection circuit has a frame memory that stores and outputs video data constituted of a plurality of consecutive data pieces. The video freeze detection circuit includes a bit substitution circuit that receives the video data, substitutes data values of particular bits of the plurality of data pieces with “0” and “1” alternately for each frame to which the data piece belongs, and then supplies the video data to the frame memory so that the plurality of data pieces are stored therein. The video freeze detection circuit further includes a data holding unit that holds data of the particular bits of the video data outputted from the frame memory, and a comparison unit compares a data value of the particular bit in the video data for one frame outputted from the frame memory with a data value of the particular bit held in the data holding unit.

### TECHNICAL FIELD

The present disclosure relates to a video freeze detection circuit that detects video freeze caused by a frame memory of a video processing device.

### BACKGROUND ART

In vehicle-mounted display devices such as electronic mirrors and CIDs (Center Information Displays), a frame memory is used to store one frame of video signals when displaying a camera image on the display. If an abnormality occurs in this frame memory, the same frame of video may be repeatedly displayed, resulting in a still image, or so-called video freeze.

To solve this problem, there has been proposed a video processing device that is provided with a configuration for determining whether or not video freeze has occurred due to a malfunction of the video processing device (for example, Japanese Patent Application Laid-open Publication No. 2022-077197).

### BRIEF DESCRIPTION OF THE DRAWINGS

FIG. 1 is a block diagram illustrating a configuration of a video freeze detection circuit according to Embodiment 1 of the present disclosure.

FIG. 2 is a diagram illustrating an example of substitution and comparison of the least significant bit.

FIG. 3 is a block diagram illustrating a configuration of a video freeze detection circuit where one frame memory is provided for each of RGB.

FIG. 4A is a diagram schematically showing a case of inverting the least significant bit of all the data in one frame.

FIG. 4B is a diagram schematically showing a case of inverting the least significant bit of only the last data of one frame.

FIG. 4C is a diagram schematically showing a case of inverting the least significant bit of only the first data of one frame.

FIG. 5 is a block diagram illustrating a video freeze detection circuit configured to replace the least significant bit after image processing is performed.

FIG. 6 is a block diagram illustrating a configuration of a video freeze detection circuit according to Embodiment 2 of the present disclosure.

FIG. 7 is a diagram illustrating an example of substitution and comparison of the least significant bit in Embodiment 2.

### DETAILED DESCRIPTION OF EMBODIMENTS

Below, preferred embodiments of the present disclosure will be explained in detail. In the descriptions and appended diagrams in each embodiment, the same reference character is given to the substantially same or equivalent parts.

### Embodiment 1

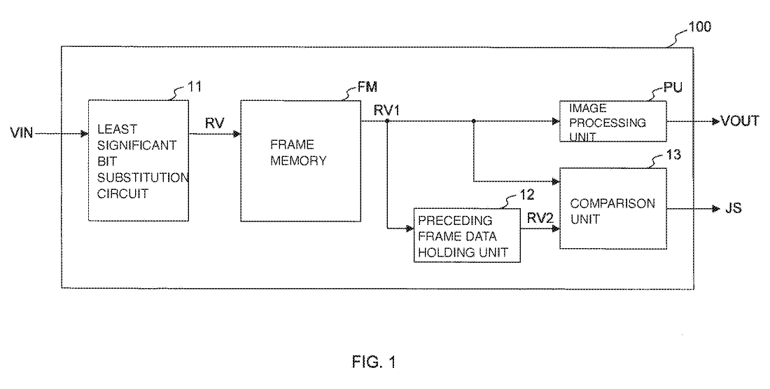

FIG. 1 is a block diagram illustrating the configuration of a video freeze detection circuit 100 according to an embodiment of the present disclosure. The video freeze detection circuit 100 is installed in a video processing device having a frame memory FM and an image processing unit PU, and detects video freeze of video data outputted from the frame memory FM.

The video freeze detection circuit 100 includes a least significant bit substitution circuit 11, a preceding frame data holding unit 12, and a comparison unit 13. The video freeze detection circuit 100 receives input video data VIN constituted of a series of data pieces.

The least significant bit substitution circuit 11 performs a process of replacing the data values of the least significant bits (LSBs) of the multiple data pieces that make up the input video data VIN with "0" and "1" alternately for each frame of the input video data VIN. The least significant bit substitution circuit 11 supplies the post-substitution video data RV, in which the data values of the least significant bits have been substituted, to the frame memory FM.

The frame memory FM is constituted of a volatile semiconductor memory device such as DRAM (dynamic random access memory). The frame memory FM receives and stores the post-substitution video data RV supplied by the least significant bit substitution circuit 11, and sequentially outputs the post-substitution video data RV for each frame. In the following description, the post-substitution video data outputted from the frame memory FM will be referred to as post-substitution video data RV1 in order to distinguish it from the post-substitution video data RV inputted to the frame memory FM. The post-substitution video data RV1 outputted from the frame memory FM is supplied to the preceding frame data holding unit 12, the image processing unit PU, and the comparison unit 13, respectively.

The preceding frame data holding unit 12 holds the post-substitution video data RV1 outputted from the frame memory FM for a holding period equivalent to one frame of the frame memory FM (i.e., the update period of the frame memory FM), and then supplies the post-substitution video data RV1 to the comparison unit 13 as post-substitution video data RV2.

The image processing unit PU performs image processing on the post-substitution video data RV1 outputted from the frame memory FM, and outputs the result as a video output VOUT.

The comparison unit 13 receives the post-substitution video data RV1 outputted from the frame memory FM and the post-substitution video data RV2 outputted from the preceding frame data holding unit 12, and compares the data values of the least significant bits of the two. The comparison unit 13 outputs a video freeze determination signal JS that indicates a logic level 0 when the two do not match, or a logic level 1 when the two match.

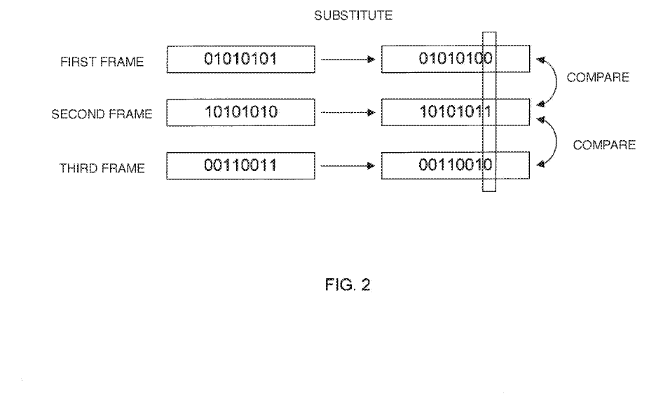

FIG. 2 is a diagram showing an example of the substitution of data values of the least significant bits performed by the least significant bit substitution circuit 11 and the comparison of the data values of the least significant bits performed by the comparison unit 13.

If the bit string of the first frame of the input video data VIN is “01010101,” the bit string of the second frame is “10101010,” and the bit string of the third frame is “00110011,” the least significant bit substitution circuit 11 replaces the data values of these least significant bits with “0” and “1” alternately for each frame, so that the bit string of the first frame of the post-substitution video data RV becomes “01010100,” the bit string of the second frame becomes “10101011,” and the bit string of the third frame becomes “00110010.”

The comparison unit 13 compares the data values of the least significant bits between the post-substitution video data RV1 and the post-substitution video data RV2, i.e., the data value of the least significant bit in the bit string of the post-substitution video data RV of one frame, with the data value of the least significant bit in the post-substitution video data RV of the preceding frame.

As described above, the data value of the least significant bit is substituted with “0” and “1” alternately for each frame by the least significant bit substitution circuit 11, and thus, if no video freeze occurs in the frame memory FM, the value will be different between the preceding frame and the current frame. Therefore, if the frame memory FM is normal, the comparison unit 13 outputs a video freeze determination signal JS in which the logical level is 0.

On the other hand, if video freeze occurs in the frame memory FM, the value of the least significant bit will be the same between the preceding frame and the current frame. Therefore, if video freeze occurs due to abnormality of the frame memory FM, the comparison unit 13 outputs a video freeze determination signal JS in which the logical level is 1.

As described above, the video freeze detection circuit 100 of this embodiment substitutes the data values of the least significant bits of the data strings of the input video data VIN with “0” and “1” alternately for each frame before the data is stored in the frame memory FM. Then, after the post-substitution video data RV, which is the video data having the substituted value, is stored in the frame memory FM, and outputted from the frame memory FM, the data values of the least significant bits of the data strings of the two consecutive frames are compared with each other. If the frame memory FM functions normally, the data value of the least significant bit will be different between the preceding frame and the current frame, and thus, by determining whether the data values of the two match or not, video freeze can be detected.

According to the video freeze detection circuit 100 of this embodiment, the occurrence of video freeze can be detected with a simple configuration, and therefore, unlike the case where a special circuit for detecting display abnormalities is provided, it is possible to detect the occurrence of video freeze without increasing the size of the device.

Even when a frame memory FM is provided for each of RGB pixels, by also providing a preceding frame data holding unit 12 and a comparison unit 13 for each of the RGB pixels, it is possible to detect video freeze in the same manner as above.

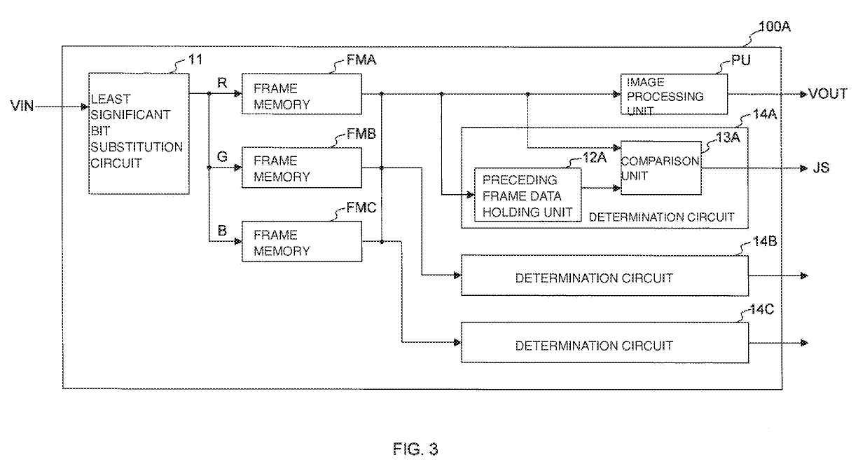

FIG. 3 is a block diagram illustrating a video freeze detection circuit 100A having such a configuration. A video processing device provided with the video freeze detection circuit 100A includes a frame memory FMA for pixel R, a frame memory FMB for pixel G, and a frame memory FMC for pixel B.

The least significant bit substitution circuit 11 performs a process of replacing the data values of the least significant bits (LSBs) of the respective multiple data pieces that make up R, G, and B of the input video data VIN, with "0" and "1" alternately for each frame. The least significant bit substitution circuit 11 supplies the R data in which the data value of the least significant bit has been substituted to the frame memory FMA, the G data with the post-substitution data value to the frame memory FMB, and the B data with the post-substitution data value to the frame memory FMC, respectively.

The video freeze detection circuit 100A includes a determination circuit 14A for the frame memory FMA, a determination circuit 14B for the frame memory FMB, and a determination circuit 14C for the frame memory FMC. The determination circuit 14A includes a preceding frame data holding unit 12A and a comparison unit 13A. The determination circuits 14B and 14C respectively have the same configuration as the determination circuit 14A.

With the video freeze detection circuit 100A having this configuration, it is possible to detect video freeze even when the frame memories FMA, FMB and FMC are provided for RGB respectively.

The data of the least significant bit to be substituted may be all of the data within one frame of the input video data VIN, or partial data only.

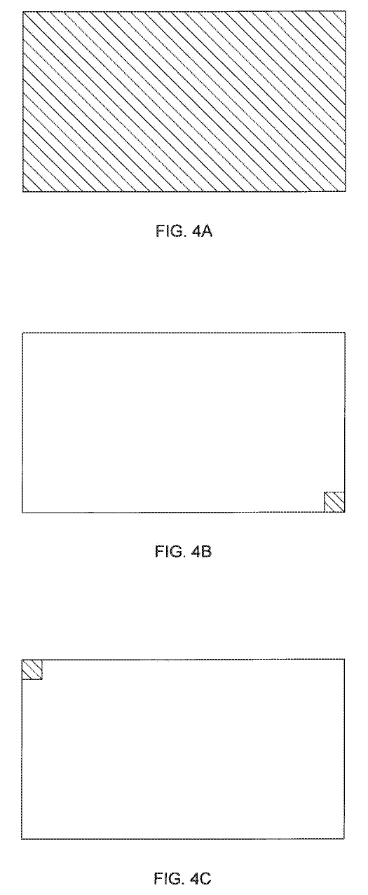

For example, as indicated with the hatching in FIG. 4A, when the substitution is performed for the least significant bits of all the data in one frame, it is possible to detect a location within one frame where video freeze occurs. Since it is possible to identify which memory cell in the frame memory FM has failed, it can be used as a simple memory failure function.

When it is not necessary to identify the location of a failed memory cell, only the last data of one frame may be subject to the least significant bit substitution as shown with the hatching in FIG. 4B, or only the first data of one frame may be subject to the least significant bit substitution as shown with the hatching in FIG. 4C to detect video freeze.

Furthermore, the substitution may be performed on other bits than the least significant bit, and by substituting the data value of any specific bit within one frame of data with "0" and "1" alternately for each frame, it is possible to achieve the same function as described in the embodiment above.

In the embodiment above, a configuration has been described in which, in a video processing device configured such that a frame memory FM precedes the image processing unit PU, video freeze is detected before the image processing unit PU perform image processing. However, even in a video processing device where the frame memory FM comes after the image processing unit PU, it is possible to detect video freeze in the same manner as the embodiment described above.

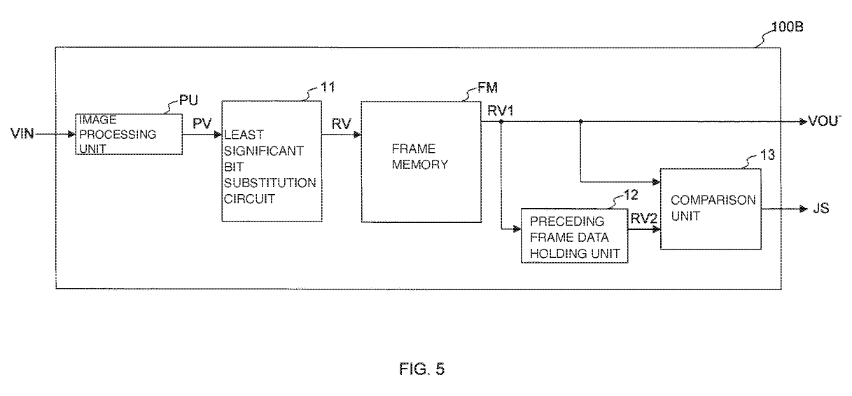

FIG. 5 is a block diagram illustrating a video freeze detection circuit 100B for a video processing device having such a configuration. The image processing unit PU performs image processing on the input video data VIN, and generates processed video data PV. The least significant bit substitution circuit 11 substitutes the data values of the least significant bits (LSBs) of the multiple data pieces that make up the processed video data PV with “0” and “1” alternately for each frame.

The configurations and operations of the frame memory FM, preceding frame data holding section 12 and comparison unit 13 are the same as those explained in the embodiment above. With this configuration, even in a video processing device where the frame memory FM comes after the image processing unit PU, it is possible to detect video freeze caused by the frame memory FM.

### Embodiment 2

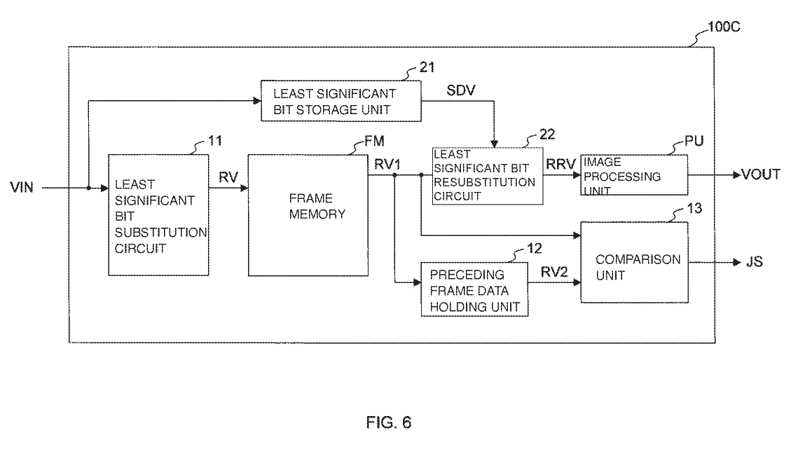

Next, Embodiment 2 of this disclosure will be explained. FIG. 6 is a block diagram illustrating a configuration of a video freeze detection circuit 100C according to Embodiment 2.

The video freeze detection circuit 100C includes a least significant bit storage unit 21 and a least significant bit resubstitution circuit 22, in addition to the least significant bit substitution circuit 11, the preceding frame data holding unit 12, and the comparison unit 13.

The least significant bit storage unit 21 stores data value of the least significant bits (LSBs) of a plurality of data pieces that make up the input video data VIN, or in other words, data values of the least significant bits that have not been substituted by the least significant bit substitution circuit 11. The least significant bit storage unit 21 supplies the stored data value SDV to the least significant bit resubstitution circuit 22.

The least significant bit resubstitution circuit 22 performs a process of resubstituting the data value of the least significant bit of the post-substitution video data RV1 outputted from the frame memory FM with the data value SDV supplied from the least significant bit storage unit 21, i.e., the data value of the least significant bit before being substituted by the least significant bit substitution circuit 11. The least significant bit resubstitution circuit 22 supplies the resubstituted video data to the image processing unit PU as resubstituted video data RRV.

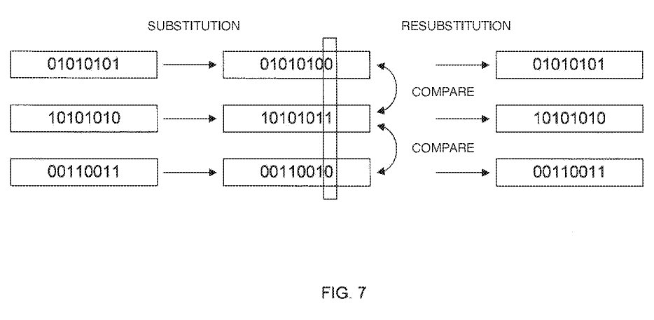

FIG. 7 is a diagram showing an example of the substitution of data values of the least significant bits performed by the least significant bit substitution circuit 11, the comparison of data values of the least significant bits performed by the comparison unit 13, and the resubstitution of data values of least significant bits performed by the least significant bit resubstitution circuit 22.

If the bit string of the first frame of the input video data VIN is “01010101,” the bit string of the second frame is “10101010,” and the bit string of the third frame is “00110011,” then after the least significant bit substitution circuit 11 replaces the respective data values, the bit string of the first frame of the post-substitution video data RV becomes “01010100,”, the bit string of the second frame becomes “10101011,” and the bit string of the third frame becomes “00110010.” The comparison unit 13 compares the data values of the least significant bits between multiple frames.

The least significant bit resubstitution circuit 22 resubstitutes the data values of the least significant bits. As a result, the bit string of the first frame of the resubstituted video data RRV, which is the data after resubstitution, becomes “01010101,” the bit string of the second frame becomes “10101010”, and the bit string of the third frame becomes “00110011”.

As described above, the video freeze detection circuit 100C of this embodiment substitutes the data values of the least significant bits of the input video data VIN, and then resubstitutes those post-substitution data values to original data values before supplying them to the image processing unit PU. According to this configuration, it is possible to perform image processing using the resubstituted video data RRV having the data value of the original input video data VIN.

### Supplementary Notes

The present specification discloses the following configurations.

### Configuration 1

1. A video freeze detection circuit provided in a video processing device having a frame memory that stores and outputs video data constituted of a plurality of consecutive data pieces for each frame, the video freeze detection circuit configured to detect video freeze of the video data outputted from the frame memory, the video freeze detection circuit including: a bit substitution circuit that receives the video data, substitutes data values of particular bits of the plurality of data pieces with “0” and “1” alternately for each frame to which the data piece belongs, and then supplies the video data to the frame memory so that the plurality of data pieces are stored therein; a data holding unit that holds data of the particular bits of the video data outputted from the frame memory; and a comparison unit compares a data value of the particular bit in the video data for one frame outputted from the frame memory with a data value of the particular bit held in the data holding unit.

### Configuration 2

The video freeze detection circuit according to Configuration 1, wherein the particular bit is a least significant bit.

### Configuration 3

The video freeze detection circuit according to Configuration 2, wherein the bit substitution circuit substitutes least significant bits in the entire video data equivalent to one frame with “0” and “1” alternately for each frame.

### Configuration 4

The video freeze detection circuit according to Configuration 1, wherein the particular bit is a bit in some pixel data of the video data equivalent to one frame.

### Configuration 5

The video freeze detection circuit according to Configuration 1, further including a storage unit that stores data values of the particular bits that have not been substituted; and a resubstitution unit that resubstitutes data values substituted by the bit substitution circuit to original data values based on the data values stored in the storage unit.

### Configuration 6

The video freeze detection circuit according to Configuration 1, wherein the bit substitution circuit substitutes a data value of the particular bit for each of RGB data of the video data, and wherein the comparison unit compares data values of the particular bit for each of the RGB data of the video data.

What is claimed is:

1. A video freeze detection circuit provided in a video processing device having a frame memory that stores and outputs video data constituted of a plurality of consecutive data pieces for each frame, the video freeze detection circuit configured to detect video freeze of the video data outputted from the frame memory, the video freeze detection circuit comprising:
a bit substitution circuit that receives the video data, substitutes data values of particular bits of the plurality of consecutive data pieces with “0” and “1” alternately for each frame to which a data piece belongs, and then supplies the video data to the frame memory so that the plurality of consecutive data pieces are stored therein;
a data holding unit that holds data of the particular bits of the video data outputted from the frame memory; and
a comparison unit that compares a data value of a particular bit in the video data for one frame outputted from the frame memory with a data value of a particular bit held in the data holding unit.

2. The video freeze detection circuit according to claim 1, wherein the particular bit in the video data and the particular bit held in the data holding unit are each a least significant bit.

3. The video freeze detection circuit according to claim 2, wherein the bit substitution circuit substitutes least significant bits in an entirety of the video data equivalent to one frame with “0” and “1” alternately for each frame.

4. The video freeze detection circuit according to claim 1, wherein the particular bit in the video data is a bit in some pixel data of the video data equivalent to one frame.

5. The video freeze detection circuit according to claim 1, further comprising:
a storage unit that stores data values of the particular bits that have not been substituted; and
a resubstitution unit that resubstitutes the data values substituted by the bit substitution circuit to original data values based on the data values stored in the storage unit.

6. The video freeze detection circuit according to claim 1, wherein the bit substitution circuit substitutes a data value of the particular bit in the video data for each of RGB data of the video data, and
wherein the comparison unit compares data values of the particular bit in the video data and the particular bit held in the data holding unit for each of the RGB data of the video data.

7. A video processing device, comprising:
a frame memory configured to store and output video data;
a bit substitution circuit coupled to the frame memory;
a data holding circuit coupled to the frame memory; and
a comparison circuit coupled to the frame memory and the data holding circuit,
wherein
the video data includes frames, each frame including data pieces,
the bit substitution circuit is configured to replace a logic value in respective data pieces in successive frames of the video data with an opposite logic value, and output the respective data pieces to the frame memory as post-substitution data,
the data holding circuit is configured to hold post-substitution data output from the frame memory for a holding period equivalent to one frame of the frame memory, and
the comparison circuit is configured to compare post-substitution data output from the frame memory with the post-substitution data held in the data holding circuit to detect video freeze of the video data.

8. The video processing device of claim 7, wherein the logic value is of a least significant bit of the respective data pieces.

9. The video processing device of claim 7, wherein the video data includes RGB data, and the frame memory comprises a first memory for R pixels, a second memory for G pixels, and a third memory for B pixels.

10. The video processing device of claim 7, further comprising:
a bit storage circuit; and
a bit resubstitution circuit coupled to the bit storage circuit and the frame memory;
wherein
the bit storage circuit is configured to receive the video data without bit resubstitution, and
the bit resubstitution circuit is configured to
receive the post-substitution data from the frame memory and the video data without bit resubstitution from the bit storage circuit,
perform resubstitution of the replaced logic value in the post-substitution data with a corresponding value from the video data without bit resubstitution, and
output resubstituted data resulting from the resubstitution to an image processing circuit.

11. A method performed by a video processing device, comprising:
replacing a logic value in respective data pieces in successive frames of video data with an opposite logic value;
outputting the respective data pieces to a frame memory as post-substitution data;
holding the post-substitution data in a holding memory for a holding period equivalent to one frame of the frame memory; and
comparing post-substitution data output from the frame memory with the post-substitution data held in the holding memory to detect video freeze of the video data.
